(19) United States
(12) Patent Application Publication
(10) Pub. No.: US 2003/0028396 A1
(43) Pub. Date: Feb. 6, 2003

(54) Method and system for modelling an instance-neutral process step based on attribute categories

(76) Inventors: Vasant Balasubramanian, Santa Clara, CA (US); Ameesh Oza, San Jose, CA (US); Krishna Uppuluri, Los Altos, CA (US)

Correspondence Address: GLENN PATENT GROUP, 3475 EDISON WAY, SUITE L, MENLO PARK, CA, 94025, US

(21) Appl. No.: 10/206,000

(22) Filed: Jul. 25, 2002

Related U.S. Application Data
(60) Provisional application No. 60/309,215, filed on Jul. 31, 2001.

(51) Int. Cl. G06F 17/60

(52) U.S. Cl. 705/1

(57) ABSTRACT

A method and system for modeling an instance neutral process step allows creation of process templates that categorize various documents, actions, data, dependencies relating to a process step and associating them in a step of a process model, condensing the diverse set of attributes into one cohesive structure. After a process step is fully modeled by configuring the various attributes, processing engines use these attributes to perform various end-user tasks such as viewing input/output data, generating reports, accessing information, and making annotations. Display attributes are specified; knowledge resources, input/output data and runtime behavior are specified and associated with a process step and later accessed by users. For each attribute that is identified, a mechanism is specified for defining and accessing the information in a step-specific manner.

### CROSS REFERENCE TO RELATED APPLICATION

This application claims benefit of U.S. Provisional Patent Application Serial No. 60/309,215, filed on Jul. 31, 2001.

### BACKGROUND OF THE INVENTION

1. Field of the Invention

In general, the invention is directed to the field of computer-based process modeling for different applications. More particularly, the invention is directed to a system and method for completely modeling a complex process step independent of a process instance, based on attribute categories.

2. Description of Related Art

In the worlds of business and academia, flow charts have been widely used to create visual models of various procedural entities such as:

Business processes;

Pseudo-code for algorithms;

Methodologies; and

Program execution scripts.

Usually, there is a ‘capture’ phase where a generic process is modeled and then a ‘deployment’ phase where users use the original process model to create instances of the process model that they can further configure and use. In other words, users of the process ‘instantiate’ the original ‘instance-neutral’ process within their own projects. Typically, current systems enable the capture of visual flow

charts with greater focus on the visual presentation and basic task/program execution aspects. An example that falls in this category is VISIO™, supplied by MICROSOFT CORPORATION, Redmond Wash. More advanced tools may also include step sequencing to direct the flow of control through the process.

Other systems (typical workflow systems) also associate instance-specific aspects such as ownership, status, time periods and input/output with process steps. For example, R. Notani, A. Parasnis, M. Whipple, Object-oriented workflow for multi-enterprise collaboration, U.S. Pat. No. 6,397,191 (May 28, 2002) describes a computer-implemented process for designing and instantiating object-oriented workflows in which instance specific input to process activities is retrieved from the source in native format and transformed into objects having a common format, which are then passed between activities in the workflow. F. Leymann, D. Roller, Method of generating an implementation of reusable parts from containers of a workflow process-model, U.S. Pat. No. 6,028,997 (Feb. 22, 2000) associates input/output containers in a separate reusable parts environment with an implementation of a process model.

Such systems ordinarily perform other project-management and task-assignment functions as well. Generally, workflow systems also provide process sequencing by ‘walking’ the users through the steps in the process, either individually or collaboratively with other users.

However, systems currently available do not provide a well-defined method and system for performing many important tasks associated with an instance-neutral process step; for example:

Accessing trouble-shooting tips or custom training about a process step (Knowledge);

Querying a bug database for all issues pertaining to a process step (Knowledge);

Viewing/Changing a specification document that relates to a process step (Data Access);

Modifying the list of data files that are the input to a process step (Data Access);

Modeling a step's data dependencies based on complex aspects such as current data/application revisions (Runtime Behavior); and

Complex post-execution compliance checks to determine if the process step was properly completed (Runtime Behavior).

While some systems may include one or more of the above capabilities in an ad hoc manner, there is currently no method or system that formally categorizes the different types of attributes pertaining to an instance-neutral process step. Further, there is no system that cohesively defines and allows user access to these capabilities in the context of a process step. As a result, a process designer is unable to completely capture and deploy a process template with all information attributes that pertain to each process step.

### SUMMARY OF THE INVENTION

The present invention provides a system and method for formally modeling an instance-neutral process step by providing several categories of attributes, including, but not limited to:

A. DISPLAY—Information required for rendering the process step by a graphical or non-graphical agent. This includes information such as display string, colors, fonts, etc.

B. KNOWLEDGE—This refers to all types of existing knowledge resources pertaining to the process step, such as, for example, user ‘Help,’ training documents, trouble-shooting tips, and Q&A wizards that provide information related to the process step. This also includes specific queries to knowledge stores (bug databases, FAQ databases, etc) to retrieve relevant information.

C. DATA ACCESS—Includes input and output data. Input data may include one or more specification documents, design files, constraints files and such. Output data may include one or more reports, data files, etc.

D. RUN-TIME ATTRIBUTES—Run-time attributes include but are not limited to:

Dependencies—Conditions that, when satisfied, indicate that the step is currently up-to-date. For instance, a process step may require a data file named ‘output.o’ to be newer that ‘input.c’. If this condition were met, then the step is up-to-date and does not need to be rerun;

Pre-conditions—Conditions that must be validated before the step is ready to run. For instance, a process step may require a data file named ‘input.c’ to exist before the step can be run. Typically, preconditions are used to check for data correctness and completeness;

Actions—Sequences of user queries, tool/program executions, database updates, etc that must be performed to realize the actual intent of the process step. For example, a process step may require a software program named ‘mytool’ to be run. Typically, actions are used to acquire user input, and perform analysis and data/state transformations; and

Post-conditions—Conditions that must be validated before the step can be accepted as passed. For example, a process step may require a data file named ‘output.c’ to exist before it can claim successful completion. Post-conditions can also include a set of compliance checks/questions that must be validated before the step can be marked as completed. Typically, post-conditions are used to validate the results of a process step.

Using the method and system of the present invention, a reusable instance-neutral process template can be created where:

Display attributes may be specified;

Knowledge resources can be associated with a process step (by the process developer) and then later accessed (by the process user);

Input and output data can be associated with a process step (by the process developer) and then later opened/viewed (by the process user). Additionally, the invention also specifies different forms of inputs and outputs and the relationships between them; and

Complex pre-conditions, actions and post-conditions can be modeled from an open and extensible set of base conditions and actions.

When a process step has been fully modeled by configuring the various attributes, processing engines use these attributes to perform various end-user tasks including but not limited to viewing input/output data, generating reports, accessing information.

### BRIEF DESCRIPTION OF THE DRAWINGS

FIG. 1 provides a chart of process step attribute categories and their corresponding attributes according to the invention;

FIG. 2 provides an architectural diagram of a system for modeling an instance neutral process step based on attribute categories according to the invention;

FIG. 3 shows a dialog box for modeling display and knowledge attributes from the system of FIG. 2 according to the invention;

FIG. 4 shows a dialog box for modeling related Links from the system of FIG. 2 according to the invention;

FIG. 5 shows a runtime component for modeling Knowledge (Related Links) according to the invention;

FIG. 6 shows a plurality of interface components for modeling data access from the system of FIG. 2 according to the invention; and

FIG. 7 shows an interface component for run-time attribute capture (Actions) according to the invention.

### DETAILED DESCRIPTION OF THE INVENTION

Overview

As shown in FIG. 1, a process 100 usually refers to one or more steps 101 that must be performed in some order to achieve a desired end result. According to the process type and the desired end result, steps may be ordered sequentially, iteratively, or in parallel. Additionally, processes may contain decision steps and hierarchical sub-processes. Processes can vary greatly in their scope and detail. Thus, a simple flowchart drawing may be used to depict an algorithm, while a more complex collaborative workflow may be necessary to capture a purchase approval process.

Unlike the various workflow systems and other tools that model processes as a whole, creating an overall process model, the invention focuses on individual steps 101 in the process and the specific activities associated with the individual step. Furthermore, unlike conventional systems that may assign instance-specific attributes to a step within the context of a specific instantiation of a process, the invention categorizes and describes those attributes that completely describe the various activities relating to a process step independent of its usage within a project/process instance. Thus, these attributes apply to the process in exactly the same manner across all instantiations.

Therefore, the instance-neutral attributes form the basis of a process template that can be reused across several project/process instances. Using the invention, a process designer is able to model an instance-neutral process step, that is, a template of a process step, by configuring attributes in a plurality of categories and associating them with the process step in an ordered, rational manner, and, subsequently, granting a process implementer and end users systematic access to knowledge, data and activities necessary for successful completion of the step in a real-world implementation.

Attribute Categories

This invention recognizes that several major attribute categories are required to completely model a process step. Such categories include, but are not limited to:

Display (105);

Knowledge (103);

Data Access (104); and

Run-time behavior (102).

Herein below, each category is described in greater detail, along with exemplary attributes 106 within the categories:

A. Display attributes (105)—Generally relate to the manner in which a process-display agent renders/draws the step. The list below is exemplary only, in systems with elaborate drawing capabilities (e.g. flowchart drawing tools), there may be many more display attributes listed here:

Display Name;

Fonts;

Text and Background Color—In systems where more attention is paid to drawing styles, these colors may also be extended to fill styles, foreground color, and so on;

Image—This image can be laid in any of several styles (top-left/center/tile, etc.) to create different visual effects for the process step;

Other Information—This can include attributes such as location, size, borders, shadows, etc.

B. Knowledge attributes (103)—Provide context-specific help/details about the process step:

Process Step Type—One of the most important attributes of a process step is its type. Merely knowing whether a process step is a decision, subflow, terminator, etc. provides a first-level of information about how this step affects the overall flow of information in the process;

Quick help—It is usually very useful to provide users with a quick note that briefly describes the process step. This type of information usually pops up as bubble help or ‘tooltips’ when the user places the computer mouse over the process step.

Documentation—When navigating a process, users usually need access to more extensive documentation that describes the process step in detail. Hence, this attribute can be set to refer to a document or URL, or a specific location within a document or URL.

Other resources/links—A process step in a knowledge-centric domain is frequently complex and encompasses information from multiple sources. These may include:

Tool/Software documentation that provides additional details about the different applications that are run as part of the process step;

Conventions and modeling style specifications that describe how to model the inputs for the step; and

Pointers to specific portions of an internal/external knowledge base that refer to this process step (by creating URLs that are web-based queries)

The process step may also include other more interactive types of links such as:

Different ways to invoke a specific tool used in the process step. For example, if the process step uses a specific tool in non-graphical (batch) mode, then a related link for the step would be a way to launch the same tool in graphical mode;

Different analyzers that can be run on the input/output data to the process step to generate reports and statistics;

Online wizards—While application notes and FAQ documents can be used to capture expert knowledge, it is usually more useful if you can actually automate this by leading the user through a sequence of steps that describe how to do some specific task related to the step. This form of expert help may require another helper process/flow or ‘wizards’ that step the user through several screens to get at a final result.

C. Data Access attributes—Inputs and outputs: a typical process step usually has some input data that determines the output results of the step. For each input/output item, it is preferable to identify at least one of:

Type of input/output data as it applies to the step:

Common Input: This input always applies in its entirety to the process step;

Driving Input: If an input is a driving input, then each of its values is responsible for ‘driving’ an iteration of the process step. Thus, if the step has a driving input with alu.v& top.v as its values, then the step will be run twice: once to transform alu.v, and the next time to transform top. v.

Dependent Input: This is an input that ‘mirrors’ the primary input in that there is a corresponding dependent input for each primary input. Hence an alu.dat may exist for the corresponding primary input alu.v.

Common Output: This is an output that is generated from the step as a whole.

Dependent Output: This is an output that ‘mirrors’ the primary output in that there is a corresponding dependent output for each primary input. Hence an alu.rpt may exist for the corresponding primary input alu.v.

Input/output item's name;

Whether the item refers to one or more files or directories or is merely a placeholder (description) for information only;

Whether the item can be specified by the user or is automatically determined in some manner

With respect to input/output type as described above, only certain combinations of these input and output types are allowed:

If a process step has driving inputs, then it cannot have any common outputs;

Only one driving input may exist for any given process step. The skilled practitioner will appreciate that the driving input may, in turn, contain one or more files each of which drives the process step separately;

One or more dependent inputs and outputs may exist for the process step only if a driving input exists;

A dependent input/output's files may optionally exist/not exist; thus, while the item may have been configured, a required file may have not yet been created, so that the item, as configured in the step model, constitutes a placeholder.

An accurate model of the inputs and outputs of a process step enables a great variety of other process-related activities, among them:

User awareness of the inputs and outputs;

Easy user access to the input and output data;

Packaging all design-related data by compiling a list of all the input & output files/directories for each step;

Reporting the process status and including the list of all input and output files;

Determining if the step needs to be rerun by checking dependencies between the inputs and outputs;

Re-updating the outputs by only running the step on some of the inputs (for example a compile step that works on several source files separately need only be rerun on those source files that have changed or are newer than their corresponding compiled output files).

D. Run-time/Execution attributes—These attributes typically control the run-time behavior of the process step. Note that these are not instance-specific attributes.

Data Dependencies—During process execution, there may exist one or more scenarios in which a process step need not be run at all, because its output data is already up-to-date. This may happen in any of several ways:

The process step is being rerun (after a feedback loop) and the dependency requirements are satisfied (inputs have not changed since the output data was last generated by the step);

Another (parallel) process step has already generated the necessary data that was to be generated from this step

The process of determining whether the inputs have changed and identifying how different changes would affect the output requires several checks including, for example:

Checking if the timestamps of all output data are more recent than all the input data (Timestamp-Based Dependency);

Checking if any file versions have changed for the input data (Version-Based Dependency);

Checking if the file content of an input has changed in a manner that affects the output: for example, changes to comments do not affect the output, changes to design parameters may affect the output. (Attribute-Based Dependency);

Checking if the versions of any tools that were used in the process step have changed (Tool Version-Based Dependency);

Thus, a single process step may have multiple data dependencies that are set on it.

It will also be evident that the data dependency attribute modeling is very heavily dependent on accurately setting up the Data Access attributes (inputs & outputs) for the process step, as previously described.

Pre-Conditions—Before a process step is allowed to start, there are typically pre-conditions that must be satisfied.

Pre-conditions may be simple (e.g. check if a design file exists) or;

More elaborate (check if a design file exists and run a preliminary analyzer to determine if the file complies with certain modeling requirements and then generate a failure report if the precondition was not met);

Complex pre-conditions may be built up from a smaller set of primitives such as:

Check if a file/directory exists;

Check if a file contains some specific contents;

Run a tool and see if it produces a set of desired results;

Ask the user one or more questions.

Actions—These are the actual procedural tasks that must be run to accomplish the purpose of the process step. Actions are modeled in an instance-neutral manner and are later applied to the instance during execution time.

Actions may range from the very simple (e.g. run a tool) to the more complex (e.g. get a list of filenames by extracting them a file, copy them to a temporary directory and run a sequence of tools in parallel on each file).

In the context of a workflow, the action may also take on a collaborative aspect that requires one or more signatories to ‘approve’ or ‘work on’ the step.

Complex actions may be built up from a smaller set of primitives such as:

Run a tool

Extract a set of patterns from a file

Create a directory

Make a query to an external database and retrieve data

Open a document (HTML/PDF/Word, etc.)

Query the user for some information (forms, wizards, etc)

Execute actions in parallel

Perform a set of actions if some conditions pass

Post-Conditions—Post-conditions, also known as compliance checks, are conditions that must be satisfied to confirm that the step passed and met some preset guidelines/requirements.

Post-conditions may take the form of a series of analysis or reporting tools or just checklists where the user can provide information and justification for their actions on the step.

Complex post-conditions may be built up from a smaller set of primitives such as:

Check if a file/directory exists;

Check if a file contains some specific contents;

Run a tool and see if it produces a set of desired results;

Ask the user one or more questions (in a checklist).

System Architecture

The invention recognizes a clear distinction between the instance-neutral and instance-specific aspects of a process. The ability to clearly identify and formalize the instance-neutral aspects of the process steps allows the process designer to define the process in all its dimensions and to create a widely reusable process template that can then be instantiated by different users for their purposes.

There is thus a preferred order (or sequence) of events that occurs in this case:

Process Designer creates process;

Process is ‘published’ in the form of files to a wider audience;

Different users ‘instantiate’ the process in their projects;

Project users interact with the process through a custom interface that understands the process model.

Architectural Overview

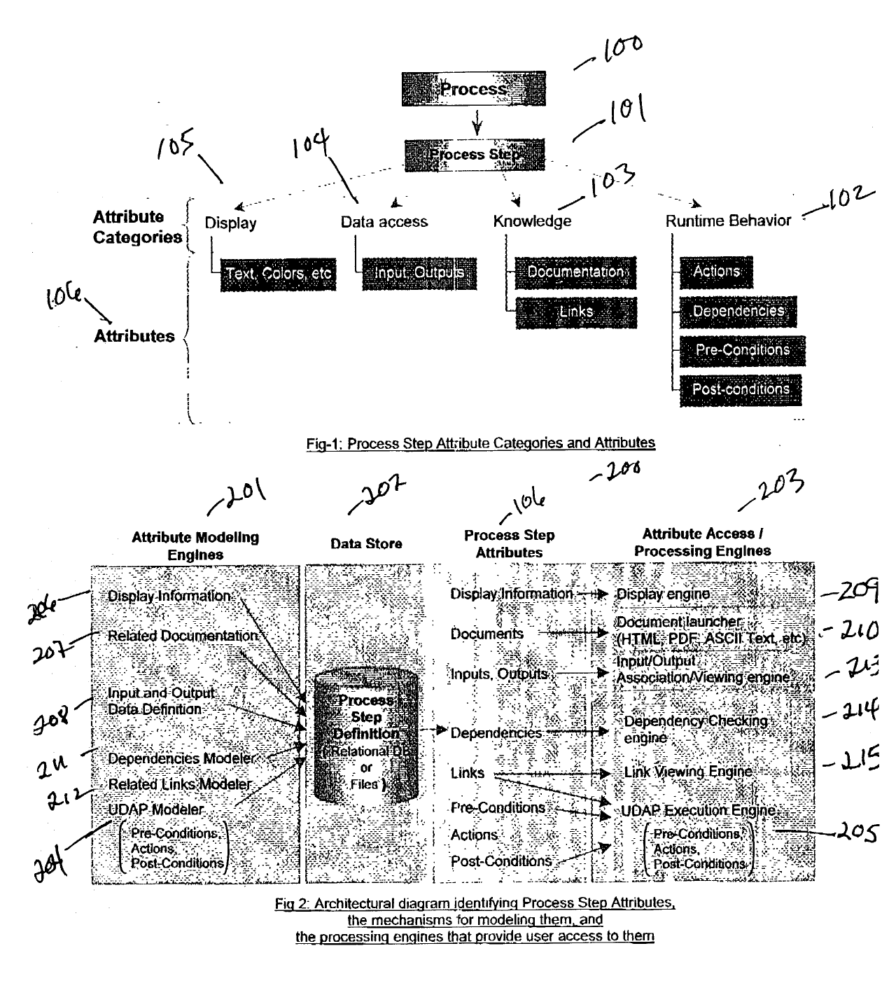

Because the set of instance-neutral process-step attributes is extremely broad in scope, it would be inflexible and inextensible to create a single monolithic system to handle the different attributes. Therefore, as shown in FIG. 2, the system 200 of the invention comprises several major functional units organized according to the order of events in the process model's lifecycle. These are:

Process-step attribute modeling (201);

Storage for the resulting process step definition (202); and

Accessing and/or processing the process step attributes (203).

Herein below are discussed all the attributes from the four attribute categories with respect to the functions of process step modeling and accessing or processing the attributes. As described above, the system also includes data store 202 to which the process step definition is stored after initial creation. While various means for storing this data are suitable for the invention, such as custom formatted files on a simple file system, XML files, or object-oriented databases, while preferred embodiments of the invention utilize relational databases. The relational database may be based on a custom format and syntax, or it may be developed using any of a number of commercial database applications.

User-Definable Action Processing Engine (UDAP Engine)

The process designer should have a powerful and extensible mechanism to express the activity that must be performed when a related link, precondition, action or post-condition is activated. Thus, the invention provides an engine that is capable of performing a set of custom conditions and actions to realize a related link, activity, pre-condition, action or post-condition.

This engine can support complex procedural logic (with conditional and looping constructs) and is extensible, thus supporting custom primitives that access the process designer's custom databases and data formats.

This engine consists of two sub-components, a modeling component 204, and an execution engine 205 that interact with the other attribute-handling engines.

The UDAP engine has several roles within the invention:

In modeling a step's pre-conditions, including such tasks as: check if a file is present and has some specific content;

In modeling a step's actions, including such tasks as: set up some input

In modeling a step's post-conditions, including such tasks as: to ask the user to fill out a compliance checklist and then perform additional checks based on a user's responses; and

In modeling a step's related links, including such tasks as: to query the user and take them to the correct document based on their responses.

The modeling component 204 is the mechanism with which the process designer defines the procedural actions/tasks to be performed. The execution engine 205 is the runtime component that takes the predefined procedural actions/tasks and applies them in the context of the current process instance.

Display Attributes

As described above, while the set of display attributes may vary depending on the application and/or system requirements, there are usually some common items including fonts, colors (text & background), image, etc. Therefore, the display-modeling engine 206 is usually tuned to the type of attributes that can be interpreted and used by the rendering engine 209. FIG. 3 shows a screen 300 through which the process designer configures the various display attributes of the process step.

Related Documentation

Related documents 207 generally include a finite set of known step-specific documents, for example a high-level training document and a more in-depth help document. These attributes are captured in the process-step modeling engine and stored in the process model as shown in FIG. 3 (301, 302).

As an end user interacts with the process model, he/she can now ask for help (or training information) on this process step. At this time, the document launcher 210 determines the viewer required for the document type (based on an external data registry) and ‘opens’ the document in the viewer.

Related Links

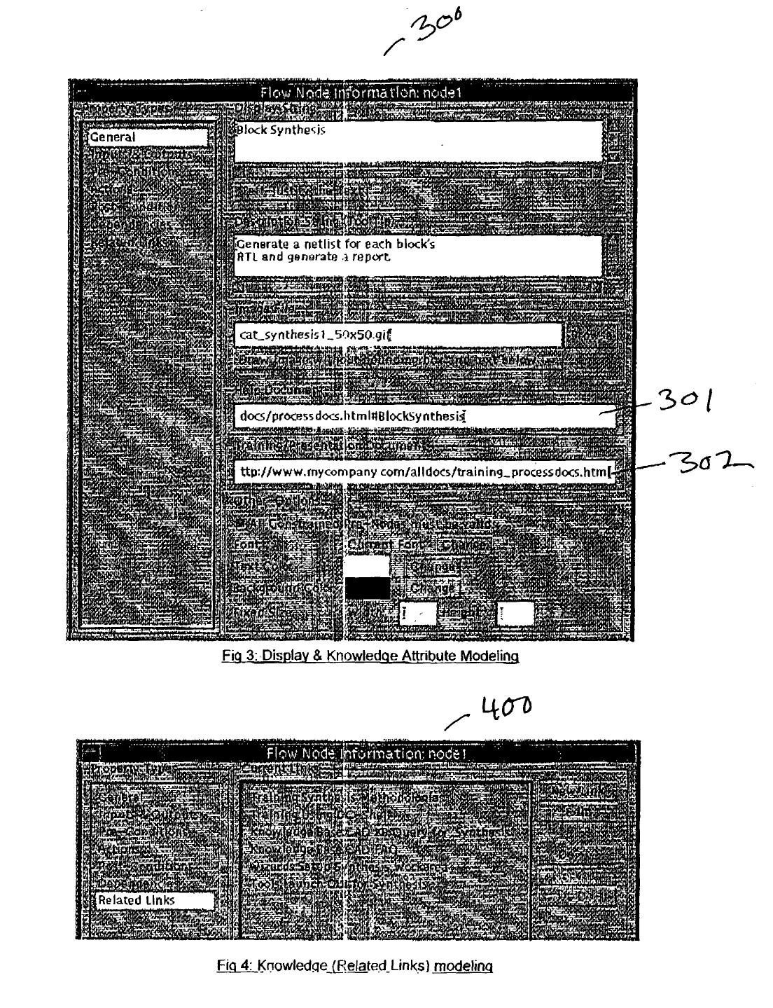

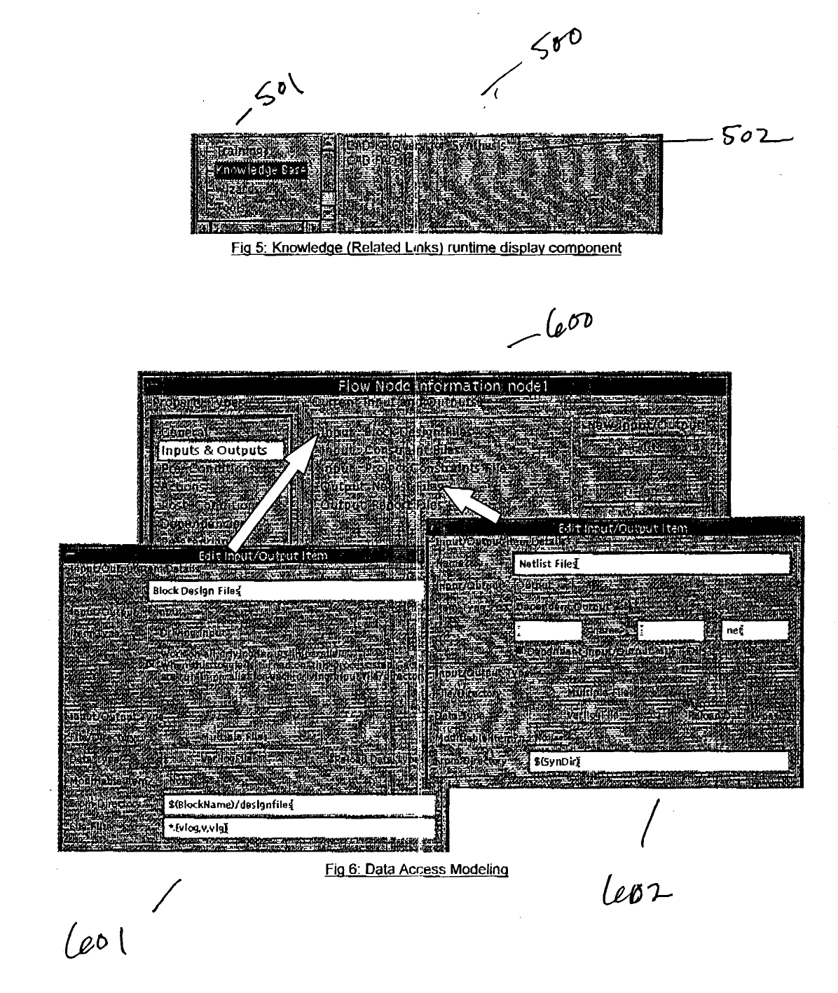

This is usually an unbound set of step-related documents/information/activities. The process designer associates one or more links with the process step by using the related links modeler 212. FIG. 4 shows an interface 400 from the related links modeler that the process designer uses to configure related links. Links can be categorized based on their pertinence (e.g. training Courses, FAQ's, expert wizards, etc) and as the end user clicks on each category 501, they are presented with a list 502 of the links within that category. Upon selecting a link, the user is navigated to the corresponding information resource.

The related links modeler 212 incorporates the modeling portion 204 of the UDAP Engine so that the process designer can exactly specify what tasks must be performed when the related links is activated. For example, activating a related link named “Synthesis Tool GUI” would have a corresponding UDAP task to launch the synthesis tool having some command-line options for invoking with a graphical user interface.

The related links processing engine 215 includes two components, as shown in the user interface 500:

Links Display 501, 502. This is a graphical component that lists all the categorized related links for the selected process step; and

Link Activation. This incorporates the UDAP Engine's runtime component 205 to perform a set of tasks when the end user clicks on the link.

Data Access (Inputs and Outputs)

The input and output-modeling component 208 allows the process designer to capture all inputs and outputs of the process step in accordance with the rules and aspects described below.

FIG. 6 shows a screen 600 from the input/output-modeling component 208 with which the process designer defines inputs and outputs. The data access model generated by this component serves as the basis for several other process and step-related activities (e.g. packaging all process inputs and outputs, determining all the step's inputs and outputs for performing dependency checks, etc). Screens 601 and 602 are edit boxes for the corresponding items from the current inputs and outputs list. Using such edit boxes, the process designer configures the parameters that define the input or output item.

The runtime data access component 213 performs a dual role. The graphical component is responsible for listing all the inputs and outputs of the selected process step. As with other components, the underlying engine 205 that generates the actual instance-specific list of input and output data is part of this runtime component and is also used from other components as well (e.g. dependency-checking component, described below).

Runtime Behavior—Dependency Checking

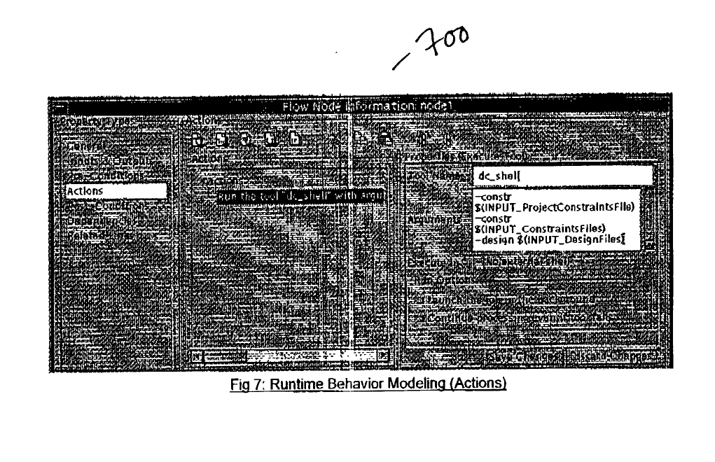

The dependency-checking engine also consists of two components—one for modeling 211 and the other for runtime dependency checking 214. As shown in FIG. 7, the process designer accesses the dependency-checking engine by selecting “dependencies” from the menu of property types.

The modeling component 211 allows the process designer to model the following types of dependencies for the process step:

Timestamp dependency: Check if the timestamps of all outputs is newer than all inputs;

File-version dependency: Check if the current file version is the same as the last time when this step was run;

File-attribute dependency: Check if some attribute (property) set in this file (or other input data) has not changed since the last time when this step was run;

Tool-version dependency: Check if the version of a tool that is used in this step's actions has not changed since the last time when this step was run; and

Tool-options dependency: Check if the options with which tools were run for this process step have changed since the last time when this step was run.

The runtime dependency-checking component 214 is incorporated into the process-execution phase by the runtime environment. Thus, when the end user asks to run a process step, the runtime environment queries the runtime dependency-checking engine to determine if the process step must be rerun or if it is already ‘up-to-date’.

Runtime Behavior—Pre-Conditions, Actions and Post-Conditions

The runtime behavioral attributes of pre-conditions, actions and post-conditions all use the UDAP engine's modeling 204 and runtime components 205 for modeling and runtime access. This simplifies and unifies the creation and management aspects of these attributes.

Exemplary use of the Invention

To illustrate an application of the invention, the case of a design team is provided that is currently designing an electronics chip. The parameters for the team are as follows:

There is a central infrastructure group that determines which design automation tools are to be used;

This central group also has charted a ‘methodology’ (or process) that identifies how different design tools are to be used (with inputs, constraints, data transformations, etc) in the context of the overall process;

This methodology includes various checklists and reporting structures at various stages to ensure the smooth evolution of the design; and

The methodology has been designed from the point of view of being reusable for later designs performed by other design teams in the same company.

While a significant portion of this effort is dedicated to capturing the overall methodology/process, this activity actually breaks down into capturing the various attributes of each step in the methodology. Using the invention, each process step, as captured in the methodology, is modeled, according to at least the following instance-neutral attributes:

Information about the type of process step;

Information about how to render a graphical representation of the step;

Documentation on how to run the step;

References to documents about the tools to be run for the step;

The ability for the designer to file a new bug for the step;

References (or database queries) that retrieve all bugs relating to that process step;

Any tips in the form of documents or wizard-like helpers that lead the user through a sequence of steps to solve a specific issue; and

A list of inputs and outputs (e.g.: Design Files, Constraints Files, Timing Report, etc).

Any inputs that must be validated before running the step. For instance, check if some specific constraints are defined in an input file.

All user queries (forms, questions, etc) and tools (interactive, non-interactive, graphical) that must be executed to actually run the step. For instance, ask the user for some tool execution options (optimization effort, log file name, etc) and then run a simulation tool.

Any checks that must be done after the step completes to validate that the step succeeded. For instance, check if the log file contained any specific warnings or errors.

All conditions that, when satisfied, indicate that the step is up-to-date. For instance, the process step's dependency may be that the tool output log file must exist and must be newer than all the input design files for the step.

The invention formalizes and categorizes these attributes for each step, thus allowing the infrastructure group (process developers) to completely model the process steps (and, thus, the process) and conveying their intent in a coherent and cohesive form. Additionally, this puts all relevant attributes pertaining to each process step at the user's fingertips in a context-sensitive and intuitive manner—thus speeding design team adoption and use of the captured design process.

Although the invention has been described herein with reference to certain preferred embodiments, one skilled in the art will readily appreciate that other applications may be substituted for those set forth herein without departing from the spirit and scope of the present invention. Accordingly, the invention should only be limited by the claims included below.

1. A method of creating a template of a process model comprising the steps of:
providing a plurality of process step attribute categories; and
for any step within said process, configuring instance-neutral attributes of said step according to said attribute categories;
wherein an instance-neutral process step definition is created that permits access to resources and end-user tasks represented by said attributes in a single step-specific structure.

2. The method of claim 1, wherein said attribute categories include:
display attributes;
knowledge;
data access; and
run-time behavior.

3. The method of claim 2, wherein said display attributes define the manner in which said step is rendered by a process display tool.

4. The method of claim 2, wherein knowledge attributes include any of:
process step type;
user help;
documentation describing said process step
documentation relating to applications run as part of said process step;
conventions and/or specifications;
step-specific pointers to a knowledge base;
methods of invoking step-related tools; and
analyzers that evaluate input and output to generate relevant reports and statistics.

5. The method of claim 2, wherein data access attributes include any of:
input type;
input name;
output type;
output name;
files and/or directories included in an item;
whether an item is a placeholder; and
whether an item is user-specified or automatically determined.

6. The method of claim 5, wherein input type includes any of:
common input;
driving input; and
dependent input.

7. The method of claim 5, wherein output type includes any of:
common output; and
dependent output.

8. The method of claim 5, wherein said step of defining instance-neutral attributes comprises limiting allowable input/output combinations.

9. The method of claim 8, wherein limiting allowable input/output combinations comprises any of the steps of:
where a step has a driving input, disallowing common output;
limiting driving inputs to one per process step;
where a step has a driving input, requiring at least one dependent output; and
in a case of dependant inputs and/or outputs, creating said item as a placeholder, wherein a required file has yet to be created.

10. The method of claim 2, wherein run-time behavior attributes include any of:
dependencies;
pre-conditions;
actions; and
post-conditions.

11. The method of claim 10, wherein dependencies include any of:
timestamp-based dependencies;
version-based dependencies;
attribute-based dependencies; and
tool version-based dependencies.

12. The method of claim 10, wherein pre-conditions include any conditions that must be satisfied before said step is run.

13. The method of claim 10, wherein complex pre-conditions are built from primitives.

14. The method of claim 10, wherein actions comprise procedural tasks that are run to accomplish said step's purpose.

15. The method of claim 10, wherein complex actions are built from primitives.

16. The method of claim 10, wherein post-conditions comprise conditions that must be satisfied to confirm that a step meets one or more preset guidelines and/or requirements.

17. The method of claim 10, wherein complex post-conditions are built from primitives.

18. The method of claim 2, wherein defining instance-neutral attributes of said step comprises:
using one or more modeling engines to configure attributes.

19. The method of claim 18, wherein said modeling engines include any of:
a display information-modeling engine;
a related documentation-modeling engine;
an input and output data definition-modeling engine;
a related links-modeling engine;
a dependencies modeling engine; and
a modeling engine for configuring any of pre-conditions, post-conditions, and actions.

20. The method of claim 1, further comprising the step of storing said instance-neutral step definition to a data store.

21. The method of claim 20, wherein said data store comprises any of:
at least one custom-formatted file on a simple file system;
at least one XML file;
an object-oriented database;
a relational database.

22. The method of claim 1, further comprising the step of:
accessing or viewing said attributes by an end user using one or more execution engines.

23. The method of claim 22, wherein said execution engines include:
a display information-execution engine;
a related documentation-execution engine;
an input and output data definition-execution engine;
a related links-execution engine;
a dependencies execution engine; and
an execution engine for executing any of pre-conditions, post-conditions, and actions.

24. A system for creating a template of a process model comprising;
a plurality of attribute categories;
means for configuring any instance-neutral attributes of any step within said process according to said attribute categories;
wherein an instance-neutral process step definition is created that permits access to resources and end-user tasks represented by said attributes in a single step-specific structure.

25. The system of claim 24, wherein said attribute categories include:
display attributes;
knowledge;
data access; and
run-time behavior.

26. The system of claim 25, wherein said display attributes define the manner in which said step is rendered by a process display tool.

27. The system of claim 25, wherein knowledge attributes include any of:
process step type;
user help;
documentation describing said process step;
documentation relating to applications run as part of a process step;
conventions and/or specifications;
step-specific pointers to a knowledge base;
methods of invoking step-related tools; and
analyzers that evaluate input and output to generate relevant reports and statistics.

28. The system of claim 25, wherein data access attributes include any of:
input type;
input name;
output type;
output name;
files and/or directories included in an item;
whether an item is a placeholder; and
whether and item is user-specified or automatically determined.

29. The system of claim 28, wherein input type includes any of:
common input;
driving input; and
dependent input.

30. The system of claim 28, wherein output type includes any of:
common output; and
dependent output.

31. The system of claim 28, wherein said means for defining instance-neutral attributes comprises means for limiting allowable input/output combinations.

32. The system of claim 31, wherein said allowable input/output combinations comprises include:
where a step has a driving input, disallowing common output;
limiting driving inputs to one per process step;
where a step has a driving input, requiring at least one dependent output; and
in a case of dependant inputs and/or outputs, creating said item as a placeholder, wherein a required file has yet to be created.

33. The system of claim 25, wherein run-time behavior attributes include any of:
dependencies;
pre-conditions;
actions; and
post-conditions.

34. The system of claim 33, wherein dependencies include any of:
timestamp-based dependencies;
version-based dependencies;
attribute-based dependencies; and
tool version-based dependencies.

35. The system of claim 33, wherein pre-conditions include any conditions that must be satisfied before a said step is run.

36. The system of claim 33, wherein complex pre-conditions are built from primitives.

37. The system of claim 33, wherein actions comprise procedural tasks that are run to accomplish said step's purpose.

38. The system of claim 33, wherein complex actions are built from primitives.

39. The system of claim 33, wherein post-conditions comprise conditions that must be satisfied to confirm that a step met one or more preset guidelines and/or requirements.

40. The system of claim 10, wherein complex post-conditions are built from primitives.

41. The system of claim 25, wherein said means for defining instance-neutral attributes of said step comprises an attribute processing engine, said attribute processing engine including one or more modeling engines to configure attributes.

42. The system of claim 41, wherein said modeling engines include any of:
a display information-modeling engine;
a related documentation-modeling engine;
an input and output data definition-modeling engine;
a related links-modeling engine;
a dependencies modeling engine;
a modeling engine for configuring any of pre-conditions, post-conditions, and actions.

43. The system of claim 41, said attribute processing engine further comprising:
one or more execution engines adapted for use by an end user to access and/or view said attributes.

44. The system of claim 43, wherein said execution engines include:
a display information-execution engine;
a related documentation-execution engine;
an input and output data definition-execution engine;
a related links-execution engine;
a dependencies execution engine; and
an execution engine for executing any of pre-conditions, post-conditions, and actions.

45. The system of claim 24, further comprising a data store, wherein said instance-neutral process step definition is stored.

46. The system of claim 45, wherein said data store comprises any of:
at least one custom-formatted file on a simple file system;
at least one XML file;
an object-oriented database; and
a relational database.
